(19) United States
(12) Patent Application Publication
(10) Pub. No.: US 2021/0096042 A1
(43) Pub. Date: Apr. 1, 2021

(54) SPECTRUM CALCULATION DEVICE AND SPECTRUM CALCULATION METHOD

(71) Applicant: Honda Motor Co.,Ltd., Tokyo (JP)

(72) Inventor: Hironori UJIKE, Saitama (JP)

(73) Assignee: Honda Motor Co.,Ltd., Tokyo (JP)

(21) Appl. No.: 17/035,743

(22) Filed: Sep. 29, 2020

(30) Foreign Application Priority Data
Sep. 30, 2019 (JP) 2019-178941

(51) Int. Cl. G01M 15/12

(52) U.S. Cl. CPC G01M 15/12

(57) ABSTRACT

The disclosure provides a spectrum calculation device and a spectrum calculation method, in which an inner product of a predetermined number of sampling data xₙ obtained by sampling and predetermined kernel functions is calculated, and spectra Spec(fᵢ) for predetermined frequencies fᵢ are calculated by calculating a square root of a sum of squares based on the calculated inner products. A difference between a latest data (x_{k, t+1)}) among the predetermined number of sampling data upon calculation of the inner product and an oldest data (x_{(1, t)}) among the predetermined number of sampling data in a previous calculation is respectively multiplied by first and second kernel functions, and an obtained value is added to a sine inner product value InSin(fᵢ, t) and a cosine inner product value InCos(fᵢ, t) obtained in the previous calculation, to update a sine inner product value InSin(fᵢ, t+1) and a cosine inner product value InCos(fᵢ, t+1).

### CROSS-REFERENCE TO RELATED APPLICATION

This application claims the priority benefit of Japan application serial no. 2019-178941, filed on Sep. 30, 2019. The entirety of the above-mentioned patent application is hereby incorporated by reference herein and made a part of this specification.

### BACKGROUND

### Technical Field

The disclosure relates to a spectrum calculation device and a spectrum calculation method which calculate a plurality of spectra respectively for predetermined frequencies and are used at the time of performing a frequency analysis on data which change in time series.

### Related Art

Conventionally, a spectrum calculation device of this type is disclosed, for example, in Patent Document 1 (Japanese Patent Application Laid-open No. 2010-180808) filed by the applicant. In Patent Document 1, in order to determine knocking in an internal combustion engine, it is applied to a frequency component analysis device which analyzes a frequency component of a detection value of a knock sensor. In this frequency component analysis device, through the knock sensor mounted on the body of the internal combustion engine, a frequency component analysis is performed on a plurality of sampling data detected at a predetermined sampling period based on short-time Fourier transform.

(a) of FIG. 7 shows sampling data detected by a knock sensor and spectrum calculation timings, and (b) of FIG. 7 shows an image of calculating a plurality of spectra for respective frequencies. As shown in (a), the values detected by the knock sensor are detected at a predetermined sampling period, and using a predetermined number k (e.g., 50) of sampling data xₙ (x₁, x₂, x₃, x₄, . . . , xₖ), a spectrum Spec(fᵢ) is calculated for a plurality of predetermined frequencies fᵢ (i=1, 2, . . . ) at predetermined calculation timings which require a frequency analysis, based on the calculation formula shown in (b).

As shown in (b) of FIG. 7, the spectrum Spec(fᵢ) at the frequency fᵢ is calculated by the following Formula (1).

$$[ Mathematical Formula 1 ]$$

$$Spec ( {f}_{i} ) = \sqrt{{\{ {\sum }_{n = 1}^{k} {x}_{n} \cdot sin ( \frac{2 π {f}_{i} n}{k} ) \}}^{2} + {\{ {\sum }_{n = 1}^{k} {x}_{n} \cdot cos ( \frac{2 π {f}_{i} n}{k} ) \}}^{2}} \qquad ( 1 )$$

As shown in Formula (1), the spectrum Spec(fᵢ) is calculated by a square root of a sum of squares including a sine wave component and a cosine wave component which serve as the kernel functions. Specifically, the first term in the square root of Formula (1) is the square of an accumulated value of the following Formula (3) regarding the product of the sampling data xₙ and the sine wave component of the following Formula (2).

$$[ Mathematical Formula 2 ]$$

$$\begin{matrix}sin ( \frac{2 π {f}_{i} n}{k} ) & ( 2 ) \\ {\sum }_{n = 1}^{k} {x}_{n} \cdot sin ( \frac{2 π {f}_{i} n}{k} ) & ( 3 )\end{matrix}$$

On the other hand, the second term in the square root of Formula (1) is the square of an accumulated value of the following Formula (5) regarding the product of the sampling data xₙ and the cosine wave component of the following Formula (4).

$$\begin{matrix}[ Mathematical Formula 3 ] & \\ cos ( \frac{2 π {f}_{i} n}{k} ) \\ {\sum }_{n = 1}^{k} {x}_{n} \cdot cos ( \frac{2 π {f}_{i} n}{k} ) & ( 3 )\end{matrix}$$

In the conventional frequency component analysis device described above, in the case where a frequency analysis is performed based on the sampling data of the knock sensor, at the timing at which the frequency analysis is necessary, as shown in FIG. 7, the spectrum Spec(fᵢ) is calculated for a plurality of frequencies fᵢ while the calculation process for obtaining the accumulated values of Formulas (3) and (5) is performed. Therefore, at the time of calculation, the processing load of an ECU, which controls the internal combustion engine, may temporarily increase, and as a result, the real-time characteristic of the ECU may be impaired. Therefore, there is room for improvement in the spectrum calculation device applied to the conventional frequency component analysis device and the like.

The disclosure provides a spectrum calculation device and a spectrum calculation method which can reduce the calculation load at the time of calculating the spectrum and can thus suppress a temporary increase in the processing load.

### SUMMARY

An embodiment of the disclosure provides a spectrum calculation device (ECU3) including a sampling means, an inner product calculation means, and a spectrum calculation means. The sampling means (a knock sensor 2 and the ECU 3 in the embodiment; the same applies in this section hereinafter) samples data, which change in time series, every predetermined time. The inner product calculation means (ECU3) calculates an inner product of a predetermined number of sampling data (sampling data xₙ, n=1, 2, . . . , k) obtained by the sampling and a predetermined first kernel function and a predetermined second kernel function, respectively. The spectrum calculation means (ECU 3) calculates a plurality of spectra Spec(fᵢ) respectively for predetermined frequencies (f₁, f₂, . . . , fᵢ) by calculating a square root of a sum of squares based on the calculated inner products. The inner product calculation means multiplies a difference between a latest data (x_{k, t+1)}) among the predetermined number of sampling data at the time of calculation and an oldest data (x_{(1, t)}) among the predetermined number of sampling data at the time of a previous calculation respectively by the first kernel function and the second kernel function at the time of calculation, and adds a thus obtained value to an inner product (previous sine inner product value InSin(fᵢ, t) and previous cosine inner product value InCos(fᵢ, t)) obtained at the time of the previous calculation, to thereby update the inner product (sine inner product value InSin(fᵢ, t+1) and cosine inner product value InCos(fᵢ, t+1)).

An embodiment of the disclosure provides a spectrum calculation method, which calculates an inner product of a predetermined number of sampling data (sampling data xₙ, n=1, 2, . . . , k) obtained by sampling data which change in time series data every predetermined time and a predetermined first kernel function and a predetermined second kernel function, respectively, and calculates a plurality of spectra. Spec(fᵢ) respectively for predetermined frequencies (f₁, f₂, . . . , fᵢ) by calculating a square root of a sum of squares based on the calculated inner products. A difference between a latest data (x_{(k, t+1)}) among a predetermined number of sampling data at the time of calculation of the inner product and an oldest data (x_{(1, t)}) among the predetermined number of sampling data at the time of a previous calculation is respectively multiplied by the first kernel function and the second kernel function at the time of calculation, and a thus obtained value is added to an inner product (previous sine inner product value InSin(fᵢ, t) and previous cosine inner product value InCos(fᵢ, t)) obtained at the time of the previous calculation, to thereby update the inner product (sine inner product value InSin(fᵢ, t+1) and cosine inner product value InCos(fᵢ, t+1)).

### BRIEF DESCRIPTION OF THE DRAWINGS

FIG. 1 is a block diagram schematically showing a control device of an internal combustion engine to which a spectrum calculation device and a spectrum calculation method according to an embodiment of the disclosure are applicable.

FIG. 2 is a flowchart showing a calculation process for calculating a spectrum.

FIG. 3 is a flowchart showing a subroutine of inner product calculation in FIG. 2.

FIG. 4 is a view for describing an inner product calculation process, in which (a) shows sampling data, (b) shows a sine inner product value at time t, (c) shows a sine inner product value at time t+1, and (d) shows a sine inner product value when a sampling number n in the sampling data of (c) is decreased by one and arranged.

FIG. 5 is a view similar to FIG. 4, in which (a) shows sampling data, (b) shows a cosine inner product value at time t, (c) shows a cosine inner product value at time t+1, and (d) shows a cosine inner product value when a sampling number n in the sampling data of (c) is decreased by one and arranged.

FIG. 6 is a view corresponding to (b) of FIG. 7 and schematically showing an image of calculating a spectrum for each frequency.

(a) of FIG. 7 shows sampling data detected by a knock sensor and spectrum calculation timings, (b) of FIG. 7 is a view showing an image of calculating a spectrum for each frequency.

### DESCRIPTION OF THE EMBODIMENTS

An embodiment of the disclosure provides a spectrum calculation device (ECU3) including a sampling means, an inner product calculation means, and a spectrum calculation means. The sampling means (a knock sensor 2 and the ECU 3 in the embodiment) samples data, which change in time series, every predetermined time. The inner product calculation means (ECU 3) calculates an inner product of a predetermined number of sampling data (sampling data xₙ, n=1, 2, . . . , k) obtained by the sampling and a predetermined first kernel function and a predetermined second kernel function, respectively. The spectrum calculation means (ECU 3) calculates a plurality of spectra Spec(fᵢ) respectively for predetermined frequencies (f₁, f₂, . . . , fᵢ) by calculating a square root of a sum of squares based on the calculated inner products. The inner product calculation means multiplies a difference bet peen a latest data (x_{(k, t+1)}) among the predetermined number of sampling data at the time of calculation and an oldest data (x_{(1, t)}) among the predetermined number of sampling data at the time of a previous calculation respectively by the first kernel function and the second kernel function at the time of calculation, and adds a thus obtained value to an inner product (previous sine inner product value InSin(fᵢ, t) and previous cosine inner product value InCos(fᵢ, t)) obtained at the time of the previous calculation, to thereby update the inner product (sine inner product value InSin(fᵢ, t+1) and cosine inner product value InCos(fᵢ, t+1)).

According to this configuration, data which change in time series are sampled every predetermined time. In addition, the inner product of the predetermined number of sampling data obtained by the sampling and the predetermined first kernel function and the predetermined second kernel function is respectively calculated. Then, the plurality of spectra respectively for the predetermined frequencies are calculated by calculating the square root of the sum of squares based on the calculated inner products. In the case of calculating the inner product based on the product of the sampling data and the kernel function by the above inner product calculation means, the difference between the latest data among the predetermined number of sampling data at the time of calculation and the oldest data among the predetermined number of sampling data at the time of the previous calculation is respectively multiplied by the first kernel function and the second kernel function at the time of calculation. Next, the thus obtained value is added to the inner product obtained at the time of the previous calculation to thereby update the inner product. Accordingly, in the calculation of the inner product for calculating the spectrum, since the inner product is updated by the above subtraction, multiplication, and addition, the calculation load can be reduced as compared with the conventional calculation method described above. As a result, the calculation load at the time of calculating the spectrum can be reduced, and thus the temporary increase in the processing load in the spectrum calculation device can be suppressed.

In an embodiment of the disclosure, in the spectrum calculation device above, the inner product calculation means executes calculation of the inner product for each sampling, and the spectrum calculation means calculates the plurality of spectra at a predetermined timing at which a frequency analysis is necessary.

According to this configuration, the calculation of the inner product is executed for each sampling, and the calculation can be performed at a low load. Therefore, compared with the conventional calculation method in which the calculation load is temporarily increased, the calculation load can be leveled to a relatively low level, and thus the calculation load can be reduced throughout the process.

An embodiment of the disclosure provides a spectrum calculation method, which calculates an inner product of a predetermined number of sampling data (sampling data xₙ, n=1, 2, . . . , k) obtained by sampling data which change in time series data every predetermined time and a predetermined first kernel function and a predetermined second kernel function, respectively, and calculates a plurality of spectra Spec(fᵢ) respectively for predetermined frequencies (f₁, f₂, . . . , fᵢ) by calculating a square root of a sum of squares based on the calculated inner products. difference between a latest data (x_{(k, t+1)}) among a predetermined number of sampling data at the time of calculation of the inner product and an oldest data (x_{(1, t)}) among the predetermined number of sampling data at the time of a previous calculation is respectively multiplied by the first kernel function and the second kernel function at the time of calculation, and a thus obtained value is added to an inner product (previous sine inner product value InSin(fᵢ, t) and previous cosine inner product value InCos(fᵢ, t)) obtained at the time of the previous calculation, to thereby update the inner product (sine inner product value InSin(fᵢ, t+1) and cosine inner product value InCos(fᵢ, t+1)).

According to this configuration, similar to the above embodiment, the inner product of the predetermined number of sampling data and the predetermined first kernel function and the predetermined second kernel function is respectively calculated, and a plurality of spectra respectively for predetermined frequencies are calculated by calculating the square root of the sum of squares based on the inner products. In the case of calculating the above inner product, the difference between the latest data among the predetermined number of sampling data at the time of calculation and the oldest data among the predetermined number of sampling data at the time of the previous calculation is respectively multiplied by the first kernel function and the second kernel function at the time of calculation, and the thus obtained value is added to the inner product obtained at the time of the previous calculation to update the inner product. Accordingly, the same operation and effect as the above embodiment can be achieved; namely, the calculation load at the time of calculating the inner product for calculating the spectrum can be reduced, so that the calculation load at the time of calculating the spectrum can be reduced, and thus the temporary increase in the processing load can be suppressed.

In an embodiment of the disclosure, in the spectrum calculation method, calculation of the inner product is executed for each sampling, and the plurality of spectra are calculated at a predetermined timing at which a frequency analysis is necessary.

According to this configuration, the same operation and effect as the above embodiment can be achieved; namely, compared with the conventional calculation method in which the calculation load temporarily increases, the calculation load can be leveled to a relatively low level and thus the calculation load can be reduced throughout the process.

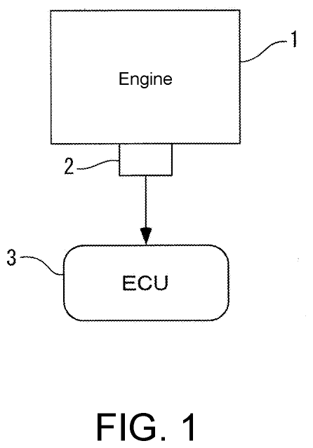

Hereinafter, exemplary embodiments of the disclosure will be described in detail with reference to the drawings. FIG. 1 schematically shows a control device of an internal combustion engine to which a spectrum calculation device and a spectrum calculation method according to an embodiment of the disclosure are applicable. As shown in the figure, the internal combustion engine (hereinafter referred to as “engine”) 1 has, for example, four cylinders, and the cylinder block of the engine 1 is provided with a knock sensor 2 (i.e., a sampling means). The knock sensor 2 is, for example, of a non-resonant type, is configured to be able to detect vibration in a predetermined frequency band (e.g., 5 to 25 kHz), and outputs the detection signal to an ECU 3 which serves as a control device.

The ECU 3 is configured with an input circuit having functions such as shaping input signal waveforms from various sensors including the knock sensor 2 above and converting an analog signal into a digital signal, a central processing unit (CPU), a memory storing various calculation programs executed by the CPU and calculation results, and an output circuit outputting a driving signal to a fuel injection valve which supplies fuel to each cylinder or an ignition plug which ignites an air-fuel mixture (none of the above is shown).

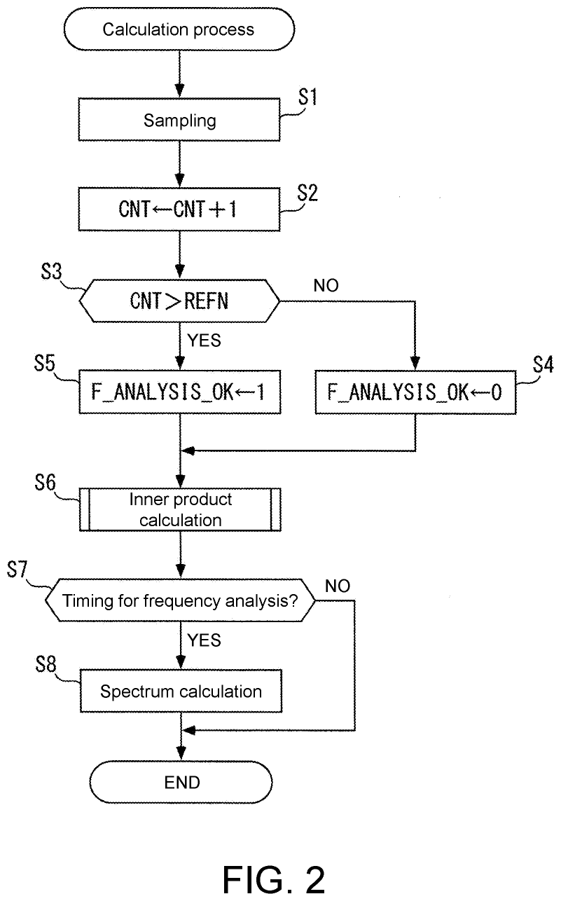

In the present embodiment, the ECU 3 performs frequency analysis based on the detection value of the knock sensor 2 for use in knocking determination of the engine 1. FIG. 2 shows a calculation process for performing frequency analysis executed in the ECU 3. The calculation process is repeatedly executed every predetermined time (e.g., 20 microseconds).

In the calculation process, first, in step 1 (shown as “S1”; the same applies hereinafter), a detection value from the knock sensor 2 is sampled. Then, a count value CNT of which the initial value is set to the value “0” is incremented by“1” (step 2), and it is determined whether the count value CNT is larger than a predetermined number REFN (step 3). The predetermined number REFN is set based on the number of data that can be subjected to frequency analysis and is set to “50” in the present embodiment, for example.

When the determination result of step 3 is “NO”, i.e., when the count value CNT is less than or equal to the predetermined number REFN, as the sampling data are few, it is assumed that it is not suitable for executing the frequency analysis, and a frequency analysis enable flag F_ANALYSIS_OK is set to “0” (step 4). On the other hand, when the determination result of step 3 is “YES” and CNT>REFN, it is assumed that the frequency analysis is possible, and the frequency analysis enable flag F_ANALYSIS_OK is set to “1” (step 5).

Next, in step 6, an inner product calculation is executed. Herein, the inner product calculation for calculating a spectrum Spec(fᵢ) according to the present embodiment will be described in detail. The index i of a frequency fᵢ in the spectrum Spec(fᵢ) is set to, for example, i=1, 2, . . . , 20. Therefore, in that case, the spectrum Spec(fᵢ) is calculated for each of the twenty different frequencies.

As described above, the spectrum Spec(fᵢ) is generally calculated by e following Formula (1), in which the inner product of sampling data xₙ and a sine wave component (see Formula (2)) which serves as the kernel function is calculated by the following Formula (3), and the inner product of the sampling data xₙ and a cosine wave component (see Formula (4)) which serves as the kernel function is calculated by the following Formula (5).

$$\begin{matrix}[ Mathematical Formula 4 ] & \\ Spec ( {f}_{i} ) = \sqrt{{\{ {\sum }_{n = 1}^{k} {x}_{n} \cdot sin ( \frac{2 π {f}_{i} n}{k} ) \}}^{2} + {\{ {\sum }_{n = 1}^{k} {x}_{n} \cdot cos ( \frac{2 π {f}_{i } n}{k} ) \}}^{2}} & ( 1 ) \\ {\sum }_{n = 1}^{k} {x}_{n} \cdot sin ( \frac{2 π {f}_{i} n}{k} ) & ( 3 ) \\ {\sum }_{n = 1}^{k} {x}_{n} \cdot cos ( \frac{2 π {f}_{i} n}{k} ) & ( 5 )\end{matrix}$$

Herein, the inner product of the sine wave component of the above Formula (3) at time t is set as in the following Formula (3A), and Formula (3) at time t is appropriately represented as a sine inner product value InSin(fᵢ, t). Similarly, the inner product of the cosine wave component of the above Formula (5) at time t is set as in the following Formula (5A), and Formula (5) at time t is appropriately represented as a cosine inner product value InCos(fᵢ, t). A sampling data x_{(n, t)} represents the sampling data at time t, and n is an integer from 1 to k (e.g., k is 50). Therefore, a sampling data x_{(k, t)} to be described later represents the k^{th} sampling data at time t, and a sampling data x_{(k, t+1)} represents the k^{th} sampling data at time t+1.

$$\begin{matrix}[ Mathematical Formula 5 ] & \\ InSin ( {f}_{i} , t ) = {\sum }_{n = 1}^{k} {x}_{( n , t )} \cdot sin ( \frac{2 π {f}_{i} n}{k} ) & ( 3 A ) \\ InCos ( {f}_{i} , t ) = {\sum }_{n = 1}^{k} {x}_{( n , t )} \cdot cos ( \frac{2 π {f}_{i} n}{k} ) & ( 5 A )\end{matrix}$$

The sine wave component on the right side of Formula (3A) and the cosine wave component on the right side of Formula (5A) respectively correspond to a first kernel function and a second kernel function of the disclosure.

Since the sine inner product value InSin(fᵢ, t) and the cosine inner product value InCos(fᵢ, t) are calculated in the same manner, in the following description, the sine inner product value InSin(fᵢ, t) will be described as example.

First, when the right side of Formula (3A) is expanded, the sine inner product value InSin(fᵢ, t) is represented by the following Formula (6).

$$\begin{matrix}[ Mathematical Formula 6 ] & \\ InSin ( {f}_{i} , t ) = {x}_{( 1 , t )} \cdot sin ( \frac{2 π {f}_{i} \cdot 1}{k} ) + {x}_{( 2 , t )} \cdot sin ( \frac{2 π {f}_{i} \cdot 2}{k} ) + … + {x}_{( k , t )} \cdot sin ( \frac{2 π {f}_{i} \cdot k}{k} ) & ( 6 )\end{matrix}$$

After one sampling of time t represented by Formula (6), a sine inner product value InSin(fᵢ, t+1) at time t+1 may be represented by the following Formula (7).

$$\begin{matrix}[ Mathematical Formula 7 ] & \\ InSin ( {f}_{i} , t + 1 ) = {x}_{( 1 , t )} \cdot sin ( \frac{2 π {f}_{i} \cdot 1}{k} ) + {x}_{( 2 , t )} \cdot sin ( \frac{2 π {f}_{i} \cdot 2}{k} ) + … + {x}_{( k , t )} \cdot sin ( \frac{2 π {f}_{i} \cdot k}{k} ) + {x}_{( k , t + 1 )} \cdot sin ( \frac{2 π {f}_{i} \cdot 1}{k} ) - {x}_{( 1 , t )} \cdot sin ( \frac{2 π {f}_{i} \cdot 1}{k} ) & ( 7 )\end{matrix}$$

In the right side of Formula (7), x_{(k, t+1)} at the right end of the second row represents the current sampling data. The subtraction term of the third row has the same value as the addition term at the left end of the first row, which is the first term, and is used to cancel it.

Further, regarding the sine wave component at the right end of the second row of Formula (7), due to the periodicity, the sine wave component with n being k+1 is equal to the sine wave component with n being 1, and thereby, the following Formula (8) is established.

$$\begin{matrix}[ Mathematical Formula 8 ] & \\ sin ( \frac{2 π {f}_{i} \cdot ( k + 1 )}{k} ) = sin ( \frac{2 π {f}_{i} \cdot 1}{k} ) & ( 8 )\end{matrix}$$

By substituting Formula (8) into the sine wave component at the right end of the second row of Formula (7), the sine inner product value InSin(fᵢ, t+1) at time t+1 is represented by the following Formula (9).

$$\begin{matrix}[ Mathematical Formula 9 ] & \\ InSin ( {f}_{i} , t + 1 ) = {x}_{( 1 , t )} \cdot sin ( \frac{2 π {f}_{i} \cdot 1}{k} ) + {x}_{( 2 , t )} \cdot sin ( \frac{2 π {f}_{i} \cdot 2}{k} ) + … + {x}_{( k , t )} \cdot sin ( \frac{2 π {f}_{i} \cdot k}{k} ) + {x}_{( k , t + 1 )} \cdot sin ( \frac{2 π {f}_{i} \cdot k}{k} ) - {x}_{( 1 , t )} \cdot sin ( \frac{2 π {f}_{i} \cdot 1}{k} ) & ( 9 )\end{matrix}$$

Then, by putting together the addition term at the right end of the second row and the subtraction term of the third row of Formula (9) through their sine wave component, the formula may be represented by the following Formula (10).

$$\begin{matrix}[ Mathematical Formula 10 ] & \\ InSin ( {f}_{i} , t + 1 ) = {x}_{( 1 , t )} \cdot sin ( \frac{2 π {f}_{i} \cdot 1}{k} ) + {x}_{( 2 , t )} \cdot sin ( \frac{2 π {f}_{i} \cdot 2}{k} ) + … + {x}_{( k , t )} \cdot sin ( \frac{2 π {f}_{i} \cdot k}{k} ) + \{ {x}_{( k , t + 1 )} - {x}_{( 1 , t )} \} \cdot sin ( \frac{2 π {f}_{i} \cdot 1}{k} ) & ( 10 )\end{matrix}$$

In the right side of Formula (10), the sum of the first row to the second row is the same as the right side of Formula (6) and is the sine inner product value InSin(fᵢ, t) at time t, i.e., at the time of the previous sampling. In other words, the sine inner product value InSin(fᵢ, t+1) at time t+1 may be represented by the following Formula (11) by using the sine inner product value InSin(fᵢ, t) at time t.

$$\begin{matrix}[ Mathematical Formula 11 ] & \\ InSin ( {f}_{i} , t + 1 ) = InSin ( {f}_{i} , t ) + \{ {x}_{( k , t + 1 )} - {x}_{( 1 , t )} \} \cdot sin ( \frac{2 π {f}_{i} \cdot 1}{k} ) & ( 11 )\end{matrix}$$

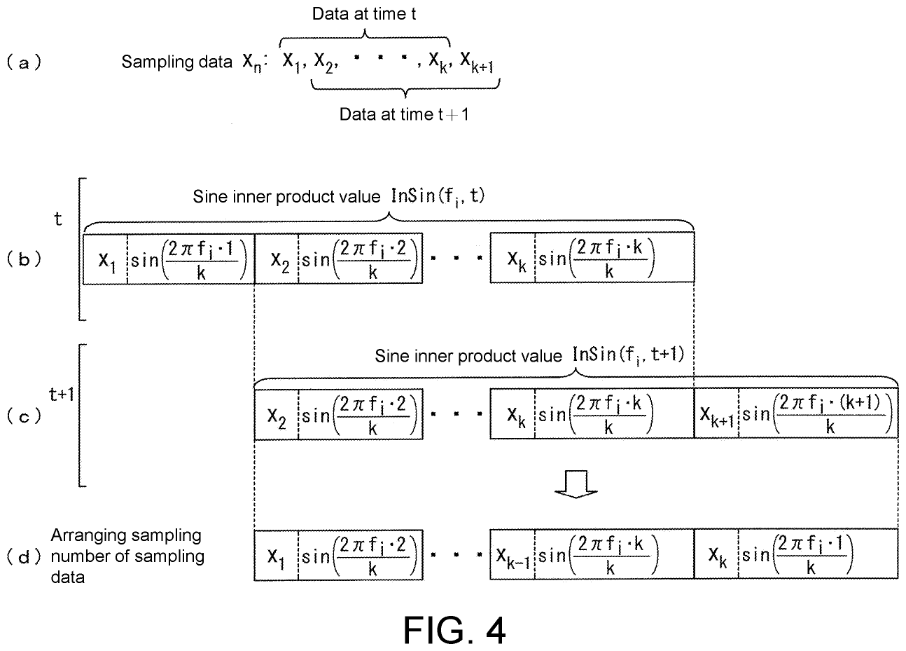

Herein, referring to FIG. 4, establishment of the above Formula (11) will be described. (a) of FIG. 4 shows the sampling data xₙ, and the sampling data xₙ of the predetermined number at time t are x₁, x₂, . . . , xₖ. On the other hand, the sampling data xₙ of the predetermined number at time t+1 are x₂, . . . , xₖ, xₖ₊₁, which are obtained by shifting by one the sampling number n in the sampling data xₙ of the predetermined number at time t.

(b) of FIG. 4 shows an image of the products of the sampling data xₙ and the sine wave component when the sampling number n is accumulated from 1 to k, and represents the sine inner product value InSin(fᵢ, t) at time t. On the other hand, (c) of FIG. 4 shows an image when the sampling number n is accumulated from 2 to k+1, and represents the sine inner product value InSin(fᵢ, t+1) at time t+1. As clearly shown in (b) and (c) of FIG. 4, compared to the sine inner product value InSin(fᵢ, t) at time t, the sine inner product value InSin(fᵢ, t+1) at time t+1 shown in (c) is obtained by adding the value of the product of the latest sampling data xₖ₊₁ and the corresponding sine wave component while subtracting the value of the product of the oldest sampling data x₁ and the corresponding sine wave component.

Further, (d) of FIG. 4 shows that in the sine inner product value InSin(fᵢ, t+1) shown in (c), the sampling number n of the sampling data xₙ at time t is arranged so as to correspond to time t+1 (n is each decreased by one), and the above Formula (8) is applied to the last sine wave component.

On the right side of the above Formula (10), when time t regarding the sampling data x_{(n, t)} of time t is updated to t+1 except the first term and the last term, the formula may be represented by the following Formula (12). In other words, by turning time t into t+1, the sampling number n of the sampling data x_{(n, t)} is decreased by 1, so on the right side of Formula (10), the sampling data x_{(2, t)} in the first row turns into x_{(1, t+1)} and the sampling data x_{(k, t)} in the second row turns into x_{(k-1, t+1)}.

$$\begin{matrix}[ Mathematical Formula 12 ] & \\ InSin ( {f}_{i} , t ) = {x}_{( 1 , t )} \cdot sin ( \frac{2 π {f}_{i} \cdot 1}{k} ) + {x}_{( 1 , t + 1 )} \cdot sin ( \frac{2 π {f}_{i} \cdot 2}{k} ) + … + {x}_{( k - 1 , t + 1 )} \cdot sin ( \frac{2 π {f}_{i} \cdot k}{k} ) + \{ {x}_{( k , t + 1 )} - {x}_{( 1 , t )} \} \cdot sin ( \frac{2 π {f}_{i} \cdot 1}{k} ) & ( 12 )\end{matrix}$$

In the right side of Formula (12), when the terms including the sampling data of time t, i.e., the addition term at the left end in the first row and the subtraction term at the right end in the third row are canceled out, the formula is represented by the following Formula (13).

$$\begin{matrix}[ Mathematical Formula 13 ] & \\ InSin ( {f}_{i} , t ) = {x}_{( 1 , t + 1 )} \cdot sin ( \frac{2 π {f}_{i} \cdot 1}{k} ) + … + {x}_{( k - 1 , t + 1 )} \cdot sin ( \frac{2 π {f}_{i} \cdot k}{k} ) + {x}_{( k , t + 1 )} \cdot sin ( \frac{2 π {f}_{i} \cdot 1}{k} ) & ( 13 )\end{matrix}$$

Formula (13) is the same as the sine inner product value InSin(fᵢ, t+1) at time t+1 as shown in (d) of FIG. 4,

From the above description, it is clear that Formula (11) holds, and therefore, the sine inner product value InSin(fᵢ, t+1) at time t+1, i.e., at the time of the current sampling (at the time of calculation) can be calculated as follows: the difference between the latest data x_{(k, t+1)} among the sampling data of the predetermined number and the oldest data x_{(1, t)} among the sampling data of the predetermined number at time t, i.e., at the time of the previous sampling (at the time of the previous calculation) (i.e., x_{(k, t+1)}−x_{(1, t)}) is multiplied by the sine wave component at that time, and the obtained value is added to the sine inner product value InSin(fᵢ, t) at the time of the previous sampling.

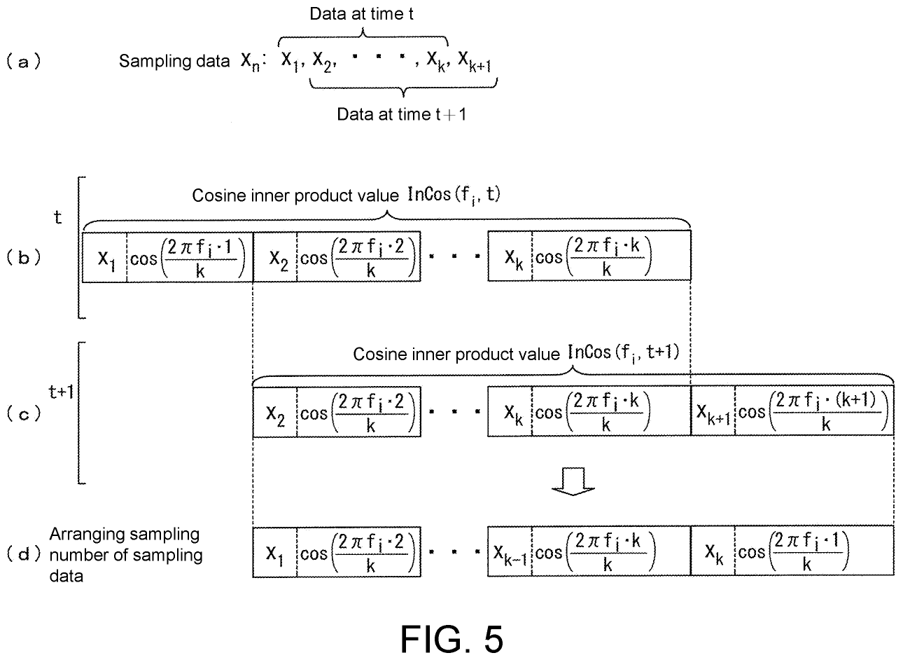

FIG. 5 is a view corresponding to FIG. 4 described above, and (b), (c), and (d) of FIG. 5 respectively show the cosine inner product value InCos(fᵢ, t) at time t, the cosine inner product value InCos(fᵢ, t+1) at time t+1, and the cosine inner product value InCos(fᵢ, t+1) at time t+1 in which the sampling number n is arranged. Further, the following Formula (14) corresponds to the above Formula (11) and shows the relationship between the cosine inner product value InCos(fᵢ, t+1) at the time of the current sampling and the cosine inner product value InCos(fᵢ, t) at the time of the previous sampling.

$$\begin{matrix}[ Mathematical Formula 14 ] & \\ InCos ( {f}_{i} , t + 1 ) = InCos ( {f}_{i} , t ) + \{ {x}_{( k , t + 1 )} - {x}_{( 1 , t )} \} \cdot cos ( \frac{2 π {f}_{i} \cdot 1}{k} ) & ( 14 )\end{matrix}$$

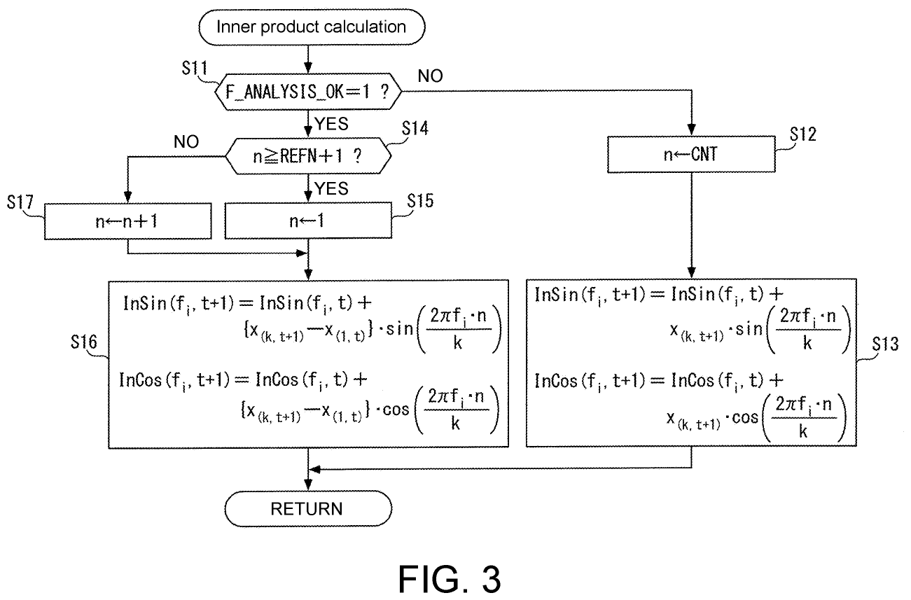

Returning to FIG. 2, in step 6, an inner product calculation is executed. FIG. 3 is a flowchart showing a subroutine of the inner product calculation of step 6. In this process, first, it is determined whether the frequency analysis enable flag F_ANALYSIS_OK set in any of steps 4 and 5 is “1” (step 11).

When the determination result is “NO”, i.e., when the number of the sampling data xₙ is less than the predetermined number REFN so it is not suitable for performing the frequency analysis, the count value CNT is set as the sampling number n (step 12), and by the following Formula (15) and Formula (16), the sine inner product value InSin(fᵢ, t+1) and the cosine inner product value InCos(fᵢ, t+1) are calculated (step 13), thus ending this process and returning to FIG. 2.

$$\begin{matrix}[ Mathematical Formula 15 ] & \\ InSin ( {f}_{i} , t + 1 ) = InSin ( {f}_{i} , t ) + {x}_{( k , t + 1 )} \cdot sin ( \frac{2 π {f}_{i} \cdot n}{k} ) & ( 15 ) \\ InCos ( {f}_{i} , t + 1 ) = InCos ( {f}_{i} , t ) + {x}_{( k , t + 1 )} \cdot cos ( \frac{2 π {f}_{i} \cdot n}{k} ) & ( 16 )\end{matrix}$$

In Formula (15) in the upper row of step 13, the current sampling data x_{(k, t+1)} is multiplied by the sine wave component, and the obtained value is added to the sine inner product value InSin(fᵢ, t) at the time of the previous sampling to thereby calculate the sine inner product value InSin(fᵢ, t+1) at the time of the current sampling. Further, in Formula (16) in the lower row of step 13, similar to the above sine inner product value InSin(fᵢ, t+1), the cosine inner product value InCos(fᵢ, t+1) at the time of the current sampling is calculated.

When the determination result of step 11 is “YES” and the frequency analysis can be executed, it is determined whether the sampling number n of the sampling data xₙ is the predetermined number REFN plus 1 or more (step 14). When the determination result is “YES” and n≥REFN+1, the sampling number n is reset to the value 1 (step 15), and by the following Formula (17) and Formula (18), the sine inner product value InSin(fᵢ, t+1) and the cosine inner product value InCos(fᵢ, t+1) are calculated (step 16), thus ending this process and returning to FIG. 2.

$$\begin{matrix}[ Mathematical Formula 16 ] & \\ InSin ( {f}_{i} , t + 1 ) = InSin ( {f}_{i} , t ) + \{ {x}_{( k , t + 1 )} - {x}_{( 1 , t )} \} \cdot sin ( \frac{2 π {f}_{i} \cdot n}{k} ) & ( 17 ) \\ InCos ( {f}_{i} , t + 1 ) = InCos ( {f}_{i} , t ) + \{ {x}_{( k , t + 1 )} - {x}_{( 1 , t )} \} \cdot cos ( \frac{2 π {f}_{i} \cdot n}{k} ) & ( 18 )\end{matrix}$$

On the other hand, if the determination result of step 14 is “NO” and the sampling number n is less than the predetermined number REFN plus 1, the sampling number n is incremented by 1 (step 17), and step 16 is executed, thus ending this process and returning to FIG. 2.

Formula (17) in the upper row of step 16 corresponds to the above Formula (11), and namely, the sine inner product value InSin(fᵢ, t+1) at the time of the current sampling (at the time of calculation) is calculated as follows: the difference between the latest data x_{(k, t+1)} among the predetermined number of the sampling data and the oldest data x_{(1, t)} among the predetermined number of the sampling data at the time of the previous sampling (at the time of calculation) (i.e., x_{(k, t+1)}−x_{(1, t)}) is multiplied by the sine wave component at that time, and the obtained value is added to the sine inner product value InSin(fᵢ, t) at the time of the previous sampling.

Similarly, Formula (18) in the lower row of step 16 corresponds to the above Formula (14), and namely, the cosine inner product value InCos(fᵢ, t+1) at the time of the current sampling (at the time of calculation) is calculated as follows: the difference between the latest data x_{(k, t+1)} among the predetermined number of the sampling data and the oldest data x_{(1, t)} among the predetermined number of the sampling data at the time of the previous sampling (at the time of calculation) (i.e., x_{(k, t+1)}−x_{(1, t)}) is multiplied by the cosine wave component at that time, and the obtained value is added to the cosine inner product value InCos(fᵢ, t) at the time of the previous sampling.

Returning to FIG. 2, in step 7, according to the current operating state or the like of the engine 1, it is determined whether it is a timing at which a frequency analysis based on the detection value of the knock sensor 2 is necessary. When the determination result is “NO” and the frequency analysis is not necessary, this process is ended as it is. On the other hand, when the determination result of step 7 is “YES” and it is a timing at which a frequency analysis is necessary, a spectrum calculation is executed (step 8), thus ending this process.

In the spectrum calculation, the spectrum Spec(fᵢ) is calculated by the following Formula (19).

$$\begin{matrix}[ Mathematical Formula 17 ] & \\ Spec ( {f}_{i} ) = \sqrt{{\{ InSin ( {f}_{i} , t + 1 ) \}}^{2} + {\{ InCos ( {f}_{i} , t + 1 ) \}}^{2}} & ( 19 )\end{matrix}$$

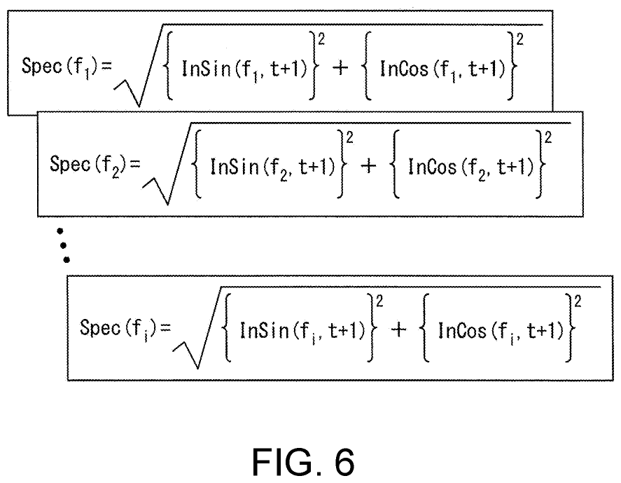

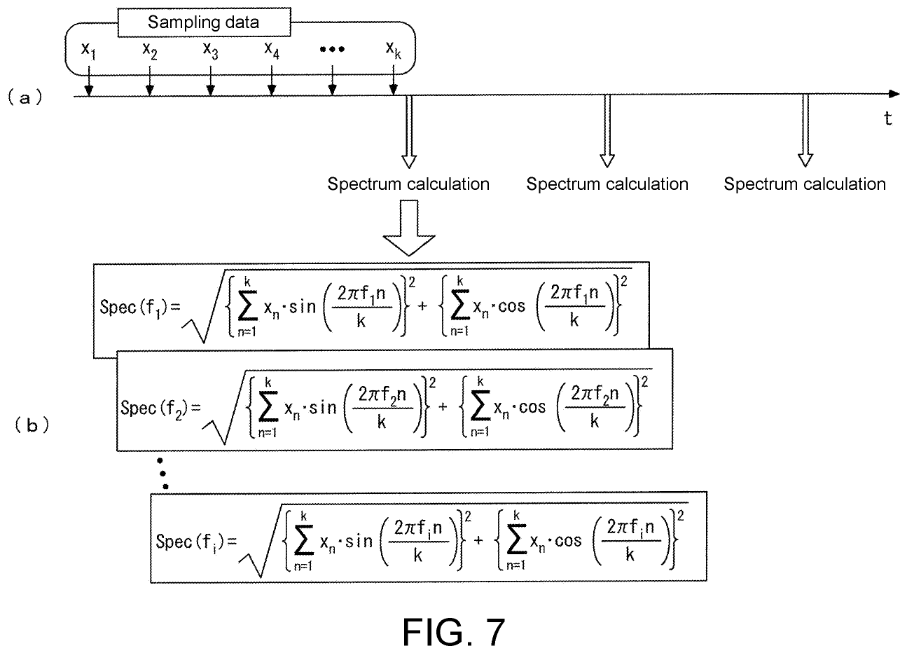

As shown in Formula (19), the spectrum Spec(fᵢ) is obtained by calculating a square root of the sum of squares of the sine inner product value InSin(fᵢ, t+1) and the cosine inner product value InCos(fᵢ, t+1) calculated by executing step 16, and therefore, in the above predetermined frequency band, as shown in FIG. 6, a plurality (e.g., 20) of spectra Spec(fᵢ) respectively for predetermined frequencies are calculated.

Although the detailed description is omitted, whether knocking occurs in the engine 1 is determined by using the spectrum Spec(fᵢ) calculated as described above.

As described above, according to the present embodiment, when calculating the sine inner product value InSin(fᵢ, t+1) and the cosine inner product value InCos(fᵢ, t+1) based on the product of the sampling data xₙ detected by the knock sensor 2 and the predetermined sine wave component and cosine wave component, the difference between the latest data x_{(k, t+1)} among the predetermined number of the sampling data at the time of calculation and the oldest data x_{(1, t)} among the predetermined number of the sampling data at the time of the previous calculation is respectively multiplied by the sine wave component and the cosine wave component at the time of calculation. Then, by adding the obtained value to the sine inner product value InSin(fᵢ, t) and the cosine inner product value InCos(fᵢ, t) obtained in the previous calculation, the sine inner product value InSin(fᵢ, t+1) and the cosine inner product value InCos(fᵢ, t+1) are updated. Therefore, in the calculation of the inner product of the present embodiment for calculating the spectrum Spec(fᵢ), by the above subtraction, multiplication, and addition, the sine inner product value InSin(fᵢ, t+1) and the cosine inner product value InCos(fᵢ, t+1) are updated, so that the calculation load in the ECU 3 can be reduced as compared with the conventional calculation method described above. As a result, the calculation load of calculating the spectrum Spec(fᵢ) can be reduced, and thus the temporary increase in the processing load in the ECU 3 can be suppressed. Further, since the above inner product calculation is executed for each sampling of the sampling data xₙ, the calculation load in the ECU 3 can be leveled to a relatively low level, and thus the calculation load can be reduced throughout the process.

The disclosure is not limited to the above-described embodiment and may be implemented in various forms. For example, in the present embodiment, in the inner product calculation, the latest one data x_{(k, t+1)} among the predetermined number of the sampling data and the oldest one data x_{(1, t)} among the predetermined number of the sampling data at the time of the previous sampling are used, and subtraction is performed on these data. However, the disclosure is not limited thereto, and instead of the above two data x_{(k, t+1)} and x_{(1, t)}, it is also possible to perform the inner product calculation based on the subtraction of a plurality of data on the latest side and a plurality of data on the oldest side.

Further, in the present embodiment, the spectrum calculation device and the spectrum calculation method of the disclosure are applied to the frequency analysis based on the detection value of the knock sensor 2 of the engine 1, but the disclosure is not limited thereto, and they may also be applied to a frequency analysis when performing voice recognition, image processing, data compression, and the like, for example.

Further, the detailed configurations of the ECU 3 and the knock sensor 2 shown in the embodiment are merely examples and may be appropriately changed within the scope of the concept of the disclosure.

What is claimed is:

1. A spectrum calculation device comprising:
a sampling means sampling data, which change in time series, every predetermined time;
an inner product calculation means calculating an inner product of a predetermined number of sampling data obtained by the sampling and a predetermined first kernel function and a predetermined second kernel function, respectively; and
a spectrum calculation means calculating a plurality of spectra respectively for predetermined frequencies by calculating a square root of a sum of squares based on the calculated inner products,
wherein the inner product calculation means multiplies a difference between a latest data among the predetermined number of sampling data at the time of calculation and an oldest data among the predetermined number of sampling data at the time of a previous calculation respectively by the first kernel function and the second kernel function at the time of calculation, and adds a thus obtained value to an inner product obtained at the time of the previous calculation, to thereby update the inner product.

2. The spectrum calculation device according to claim 1, wherein the inner product calculation means executes calculation of the inner product for each sampling, and
the spectrum calculation means calculates the plurality of spectra at a predetermined timing at which a frequency analysis is necessary.

3. A spectrum calculation method, which calculates an inner product of a predetermined number of sampling data obtained by sampling data which change in time series every predetermined time and a predetermined first kernel function and a predetermined second kernel function, respectively, and calculates a plurality of spectra respectively for predetermined frequencies by calculating a square root of a sum of squares based on the calculated inner products,
wherein a difference between a latest data among the predetermined number of sampling data at the time of calculation of the inner product and an oldest data among the predetermined number of sampling data at the time of a previous calculation is respectively multiplied by the first kernel function and the second kernel function at the time of calculation, and a thus obtained value is added to an inner product obtained at the time of the previous calculation, to thereby update the inner product.

4. The spectrum calculation method according to claim 3, wherein calculation of the inner product is executed for each sampling, and the plurality of spectra are calculated at a predetermined timing at which a frequency analysis is necessary.
